(19) United States
(12) Patent Application Publication
(10) Pub. No.: US 2016/0368235 A1
(43) Pub. Date: Dec. 22, 2016

(54) HOT PRESSING MOLD FOR PULP MOLDING AND MANUFACTURING METHOD THEREOF

(71) Applicant: GOLDEN ARROW PRINTING CO., LTD., New Taipei City (TW)

(72) Inventors: Chien-Kuan KUO, New Taipei City (TW); Chun-Huang HUANG, New Taipei City (TW)

(21) Appl. No.: 14/852,161

(22) Filed: Sep. 11, 2015

(30) Foreign Application Priority Data
Jun. 16, 2015 (TW) 104119485

(51) Int. Cl. B31B 43/00; D21F 13/00

(52) U.S. Cl. CPC B31B 43/00; D21F 13/00

(57) ABSTRACT

In a hot pressing mold for pulp molding and its manufacturing method, the hot pressing mold includes a first mold and a second mold. The first mold has a first surface, a first mold cavity formed on the first surface, and a planar section disposed around the periphery of the first mold cavity. The first mold is engaged with the second mold. The second mold has a second surface, a second mold cavity formed on the second surface, a ridge disposed on the outer side of the second mold cavity, an inclined wall formed on a side of the ridge near the lateral side of the second mold cavity. An obtuse angle is included between the inclined wall and the second surface, and second mold cavity and the first mold cavity are pressed and engaged, and the ridge and the planar section are pressed and engaged.

### FIELD OF THE INVENTION

The technical field relates to a hot pressing mold of a paper box, more particularly to a hot pressing mold for pulp molding and its manufacturing method.

### BACKGROUND OF THE INVENTION

Due to factors such as environmental pollution, drastic climatic change, and energy shortages, most people nowadays select and purchase products which are environmentally protecting, free of pollution, and reusable. Among these products, paper products made of pulp which is recycled from paperboard and newspaper and then formed by molding, are environmentally protecting, free of pollution, and reusable, thus becoming a popular packaging material

After a preliminary formed product is made by pulp molding, an extension is reserved at the periphery of the preliminary formed product and provided for a cutting operation, so that the preliminary formed product may be cut into a paper box with determined dimensions. In addition, the cutting tool used in present cutting processes such as punching or bending usually performs the cutting in a direction perpendicular to the extension, so that the edge of an extension plate at the periphery of the paper box is substantially right-angled.

However, the right-angled edge at the periphery of the paper box has the following shortcomings. Since packaging boxes for packaging commercial products have to be stacked on top of one another, the periphery of each paper box is in contact with the periphery of another paper box. Compared with an inclined edge, the right-angled edges of the paper box have smaller contact area and less friction, so that the stability of stacking the packaging boxes is poor.

In view of the aforementioned problems of the prior art, the inventor of this disclosure based on years of experience in the industry in conducting extensive research and experiments, finally invented a hot pressing mold for pulp molding and its method to overcome the problems of the prior art.

### SUMMARY OF THE INVENTION

It is a primary objective of this disclosure to provide a hot pressing mold for pulp molding and a method thereof, wherein the hot pressing mold is used in a cutting operation, so that the external periphery of a paper product so produced has an inclined edge, and the inclined edge is capable of increasing the contact friction, so that when the external periphery of the paper product is in contact with a package cover, the stability of stacking the paper product with the package cover is greater.

To achieve the aforementioned objective, this disclosure provides a hot pressing mold for pulp molding, and the hot pressing mold comprises: a first mold, having a first surface, a first mold cavity formed on the first surface, and a planar section disposed around the periphery of the first mold cavity; and a second mold, engaged with the first mold, and having a second surface, a second mold cavity being formed on the second surface, and a ridge being disposed on an outer side of the second mold cavity, and the ridge having an inclined wall disposed on a side proximate to the second mold cavity, and an obtuse angle being included between the inclined wall and the second surface, and the second mold cavity being pressed and engaged with the first mold cavity, and the ridge being pressed and engaged with the planar section.

To achieve the aforementioned objective, this disclosure further provides a manufacturing method of a paper, and the method comprises the following steps:

(a) Provide a hot pressing mold which includes a first mold and a second mold, wherein the first mold has a first surface, a first mold cavity formed on the first surface has and a planar section disposed around the periphery of the first mold cavity, and the second mold has a second surface, and the second surface includes a second mold cavity and a ridge disposed on an outer side of the second mold cavity, and the ridge has an inclined wall on a side of the ridge near the second mold cavity, and an obtuse angle is included between the inclined wall and the second surface.

(b) Provide a paper wet blank, and put the paper wet blank on the first mold.

(c) Perform mold clamping and heating operations of the second mold and the first mold, so that the paper wet blank is hot pressed to form a paper preliminary formed product, and the paper preliminary formed product is pressed by the second mold cavity and the first mold cavity to form a main body, and the paper preliminary formed product is pressed by the ridge and the planar section to form an extension plate and a trench, and the interior of the trench is pressed by the inclined wall to form an inclined edge, and the inclined edge has a bottom edge.

(d) Perform a mold opening operation of the second mold and the first mold, so that the paper preliminary formed product is detached from the hot pressing mold.

(e) Align the bottom edge precisely for the cutting operation, so that the paper preliminary formed product is cut into a paper product, and the inclined edge is formed at the external periphery of the paper product.

The hot pressing mold for pulp molding and its manufacturing method of this disclosure have the following effects:

1. The hot pressing mold is used in the cutting operation to achieve the effect of having an inclined edge at the external periphery of the paper product, so as to overcome the problem of the conventional paper box with a right-angled external periphery.

2. Compared with the conventional perpendicular edge formed at the external periphery of a paper product, the inclined edge improves the contact area and friction, so that when the inclined edge of the paper product is contact with the package cover, the stability of stacking the paper product onto the package cover is improved.

3. Since the inclined edge is formed by being pressed by the inclined wall, therefore the area of the inclined edge being compressed has a greater density to provide a higher structural strength and combine with the package cover more securely.

### BRIEF DESCRIPTION OF THE DRAWINGS

FIG. 1 is a flow chart of a manufacturing method of a paper box of this disclosure;

FIG. 2 is a perspective view of a hot pressing mold of this disclosure;

FIG. 3 is a schematic view of a first mold and a second mold of this disclosure to be clamped with each other;

FIG. 4 is a schematic view of a paper wet blank of this disclosure which is hot pressed into a paper preliminary formed product;

FIG. 5 is a schematic view of the interior of a trench which is pressed by an inclined wall to form an inclined edge in accordance with this disclosure;

FIG. 6 is a schematic view of a paper preliminary formed product detached from a hot pressing mold in accordance with this disclosure;

FIG. 7 is a schematic view of performing a cutting operation precisely at a bottom edge in accordance with this disclosure;

FIG. 8 is a schematic view of an inclined edge formed at the external periphery of a paper product in accordance with this disclosure;

FIG. 9 is a schematic view of a using status of a paper box of this disclosure;

FIG. 10 is an exploded view of another exemplary embodiment of a hot pressing mold of this disclosure; and

FIG. 11 is an exploded view of a further exemplary embodiment of a hot pressing mold of this disclosure.

### DESCRIPTION OF THE PREFERRED EMBODIMENTS

The technical contents of this disclosure will become apparent with the detailed description of preferred embodiments accompanied with the illustration of related drawings as follows.

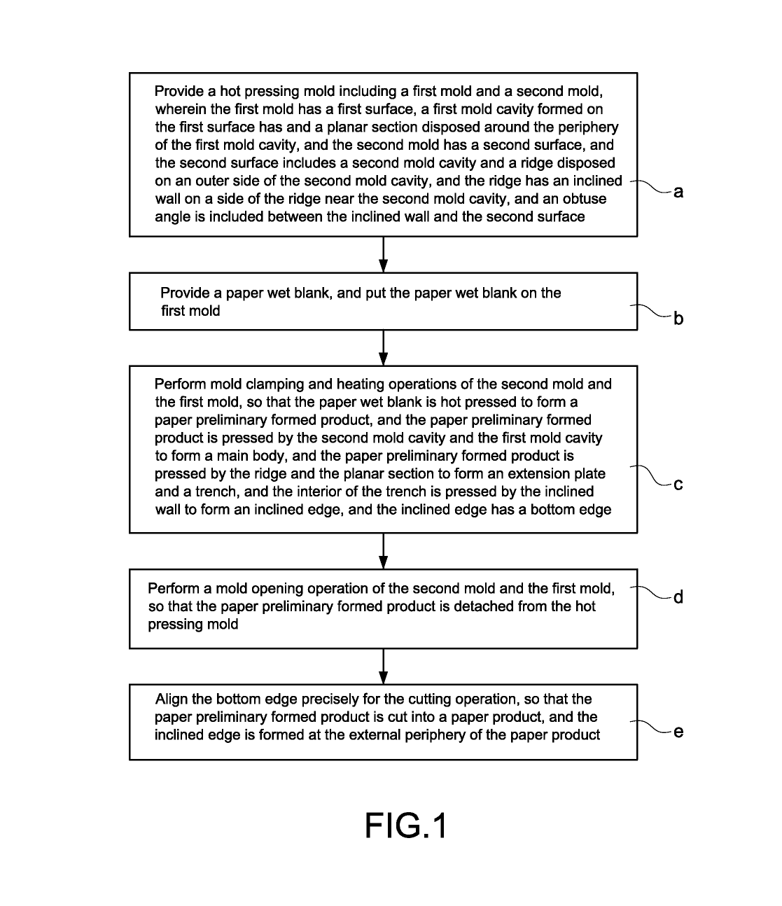

With reference to FIGS. 1 to 9 for a hot pressing mold for pulp molding and a manufacturing method thereof in accordance with this disclosure, the hot pressing mold 10 comprises a first mold 1 and a second mold 2.

FIG. 1 shows a flow chart of a manufacturing method of this disclosure.

First Step (as shown in Step (a) of FIG. 1 and FIGS. 2 and 3): Provide a hot pressing mold 10. The hot pressing mold 10 comprises a first mold 1 and a second mold 2, and the first mold 1 has a first surface 11, a first mold cavity 111 formed on the first surface 11 and a planar section 112 disposed around the periphery of the first mold cavity 111, and the second mold 2 has a second surface 21, a second mold cavity 211 formed on the second surface 21, a ridge 212 disposed on an outer side of the second mold cavity 211, and an inclined wall 213 formed on a side of the ridge 212 near the second mold cavity 211, wherein an obtuse angle θ1 is formed between the inclined wall 213 and the second surface 21.

In this embodiment, there are two ridges 212 disposed on both sides of the second mold cavity 211 respectively, and each of the ridges 212 is a long-strip projection 214, and the second mold cavity 211 has a length smaller than the length b of the ridge 212. Wherein, the obtuse angle θ1 preferably falls within a range from 120 degrees to 150 degrees, but it is not limited to such range only.

In addition, the first mold cavity 111 of this embodiment is a female mold cavity, and the second mold cavity 211 of this embodiment is a male mold cavity, but they are not limited to such arrangements only. The shape of the second mold cavity 211 and the first mold cavity is not limited that of this embodiment only, but it can be adjusted or designed according to the actual requirements. In addition, the ridge 212 of this embodiment has a cross-section in the shape including but not limited to a triangular shape.

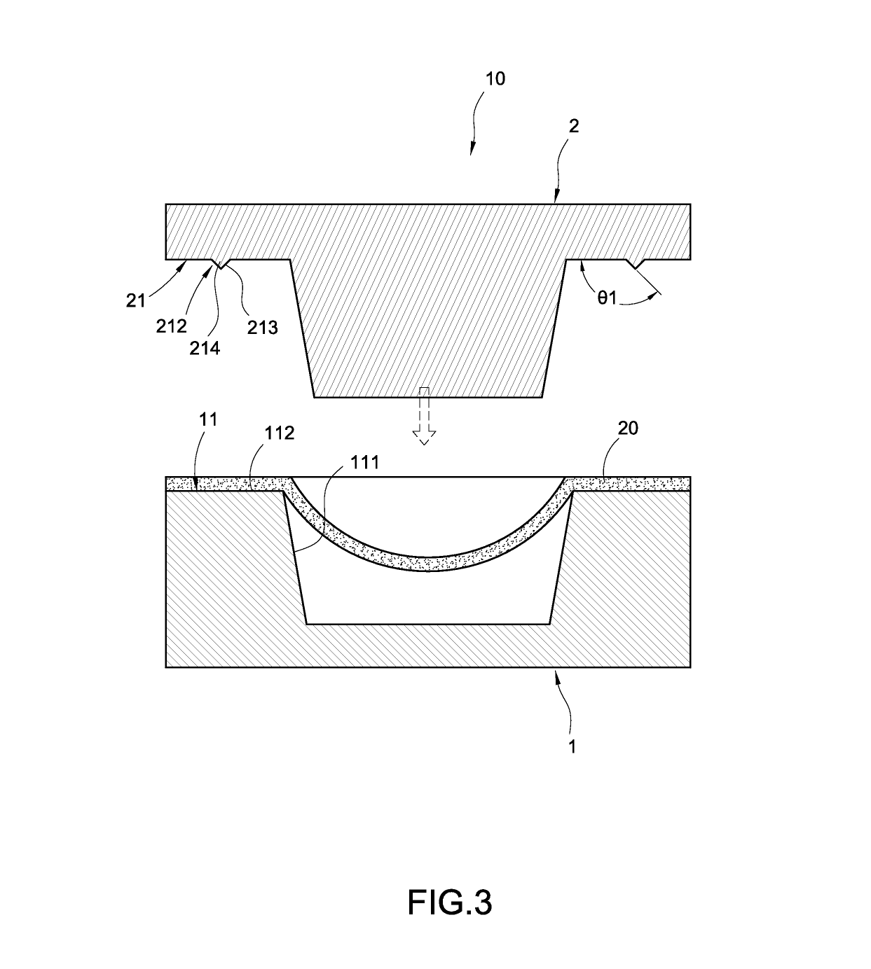

Second Step (as shown in Step (b) of FIG. 1 and FIG. 3): Provide a paper wet blank 20, and put the paper wet blank 20 on the first mold 1, so that the second mold cavity 211 is compressed and engaged with the first mold cavity 111, and the ridge 212 is compressed and engaged with the planar section 112.

Third Step (as shown in Step (c) of FIG. 1 and FIGS. 4 and 5): Perform mold clamping and heating operations of the second mold 2 and the first mold 1, so that the paper wet blank 20 is hot pressed to form a paper preliminary formed product 30, and the paper preliminary formed product 30 is compressed by the second mold cavity 211 and the first mold cavity 111 to form a main body 301, and the paper preliminary formed product 30 is compressed by the ridge 212 and the planar section 112 to form an extension plate 302 and a trench 303, and the interior of the trench 303 is compressed by the inclined wall 213 to form an inclined edge 304, and the inclined edge 304 has a bottom edge 305.

Since there is an obtuse angle θ1 included between the inclined wall 213 and the second surface 21, therefore the angle θ2 included between the bottom surface 3021 of the extension plate 302 and the inclined edge 304 is an acute angle. In addition, the obtuse angle θ1 preferably falls within a range from 120 degrees to 150 degrees, and thus the angle θ2 preferably falls within a range from 30 degrees to 60 degrees.

In addition, there are two ridges 212 formed on both sides of the second mold cavity 211 respectively, so that there are also two trenches to match with the ridges 212, and the two trenches 303 are formed on both sides of the main body 301 respectively.

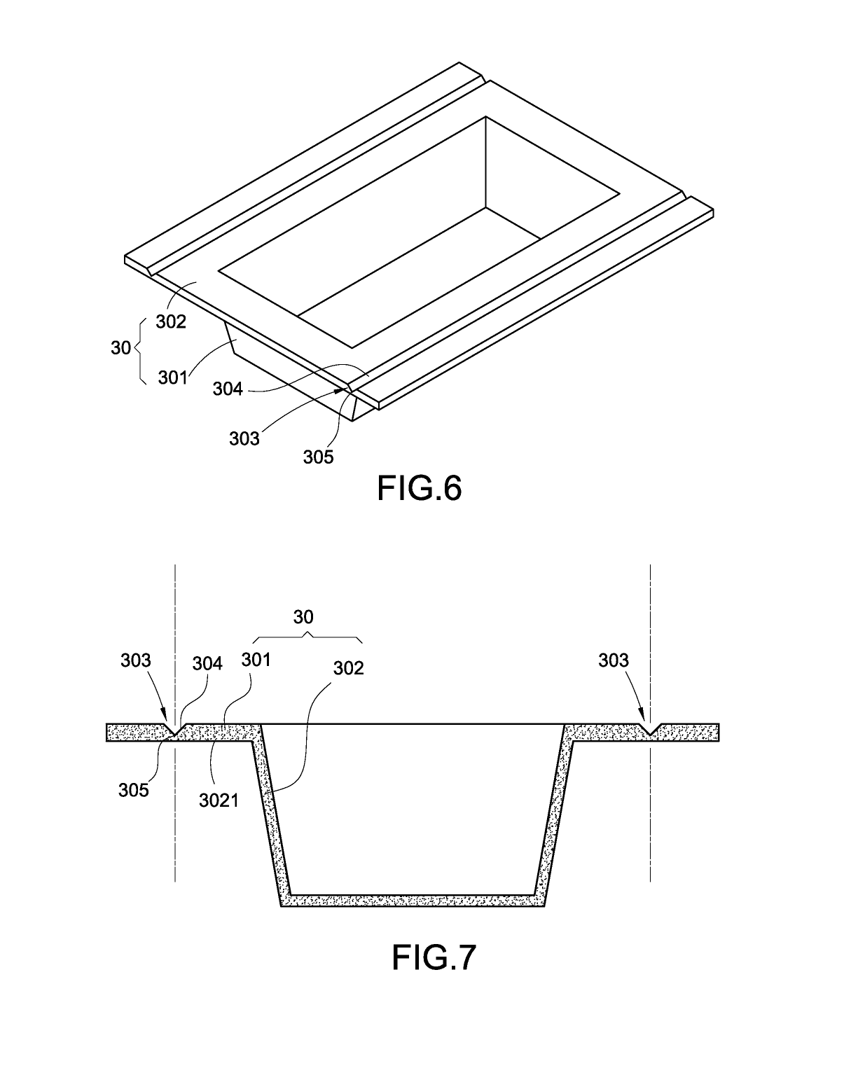

Fourth Step (as shown in Step (d) of FIG. 1 and FIG. 6): Perform a mold opening operation of the second mold 2 and the first mold 1, so that the paper preliminary formed product 30 is detached from the hot pressing mold 10.

Fifth Step (as shown in Step (e) of FIG. 1 and FIGS. 7 and 8): Align the bottom edge 305 precisely for a cutting operation, so that the paper preliminary formed product 30 is cut into a paper product 40, and the inclined edge 304 is formed at the external periphery of the paper product 40. Wherein, the cutting operation provides a cutting tool for aligning precisely with the bottom edge 305 for cutting by punching or bending.

There are two ridges 212 and two trenches 303, and the two trenches 303 are formed on both sides of the main body 301 respectively, so that the inclined edges 304 are formed on opposite sides of the external periphery of the paper product 40 respectively.

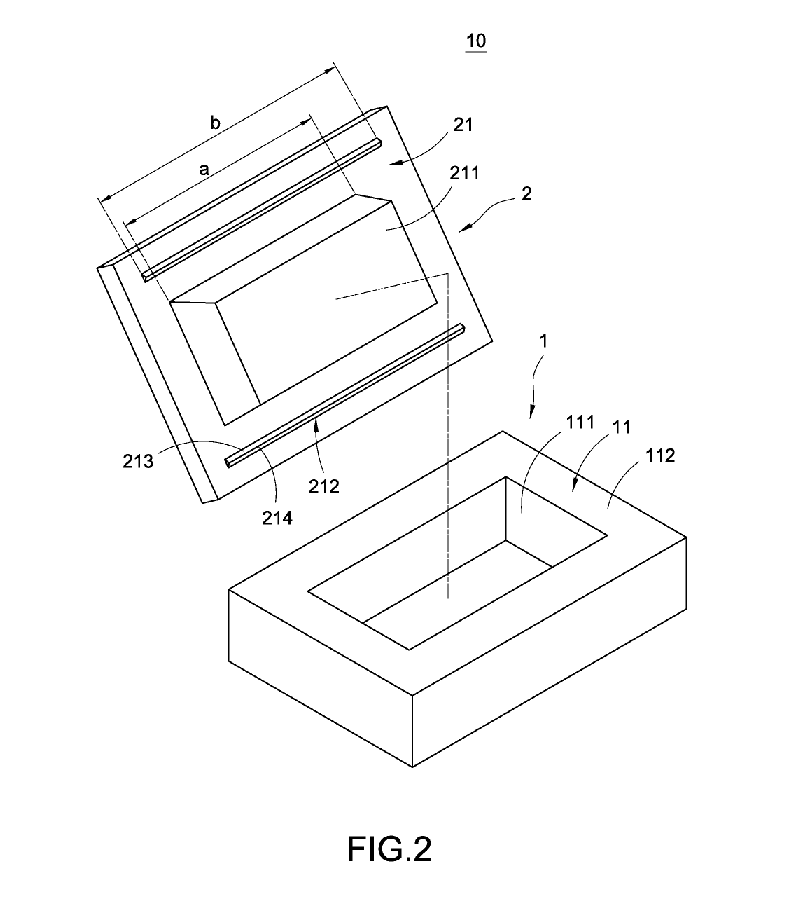

With reference to FIGS. 2 to 5 for the assembly of a hot pressing mold 10 of this disclosure, the first mold 1 has a first surface 11, a first mold cavity 111 formed on the first surface 11 and a planar section 112 disposed around the periphery of the first mold cavity 111; the second mold 2 and the first mold 1 are engaged with each other; the second mold 2 has a second surface 21, a second mold cavity 211 formed on the second surface 21, a ridge 212 disposed on an outer side of the second mold cavity 211, an inclined wall 213 formed on a side of the ridge 212 near the second mold cavity 211, and an obtuse angle θ1 included between the inclined wall 213 and the second surface 21; and the second mold cavity 211 is compressed and engaged with the first mold cavity 111, and the ridge 212 is compressed and engaged with the planar section 112.

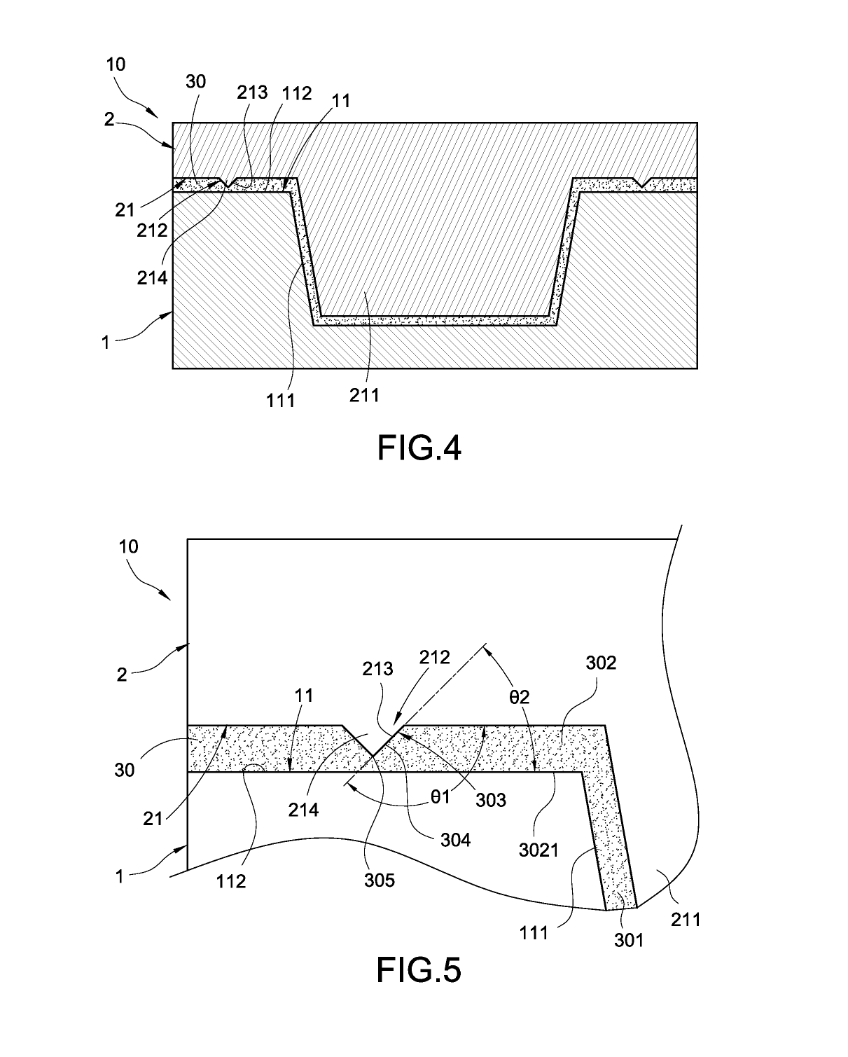

With reference to FIGS. 4 to 8 for the using statues of the hot pressing mold 10 of this disclosure, the paper preliminary formed product 30 is compressed by the second mold cavity 211 and the first mold cavity 111 to form a main body 301, and the paper preliminary formed product 30 is compressed by the ridge 212 and the planar section 112 to form an extension plate 302 and a trench 303, and the interior of the trench 303 is compressed by the inclined wall 213 to form an inclined edge 304, wherein the inclined edge 304 has a bottom edge 305, and then the bottom edge 305 is aligned precisely for a cutting operation, so that the paper preliminary formed product 30 is cut into a paper product 40, and the inclined edge 304 is formed at the external periphery of the paper product 40. The hot pressing mold 10 is used in the cutting operation to achieve the effect of forming the inclined edge 304 at the external periphery of the paper product 40 to overcome the problem of the conventional paper box having the right-angled external periphery.

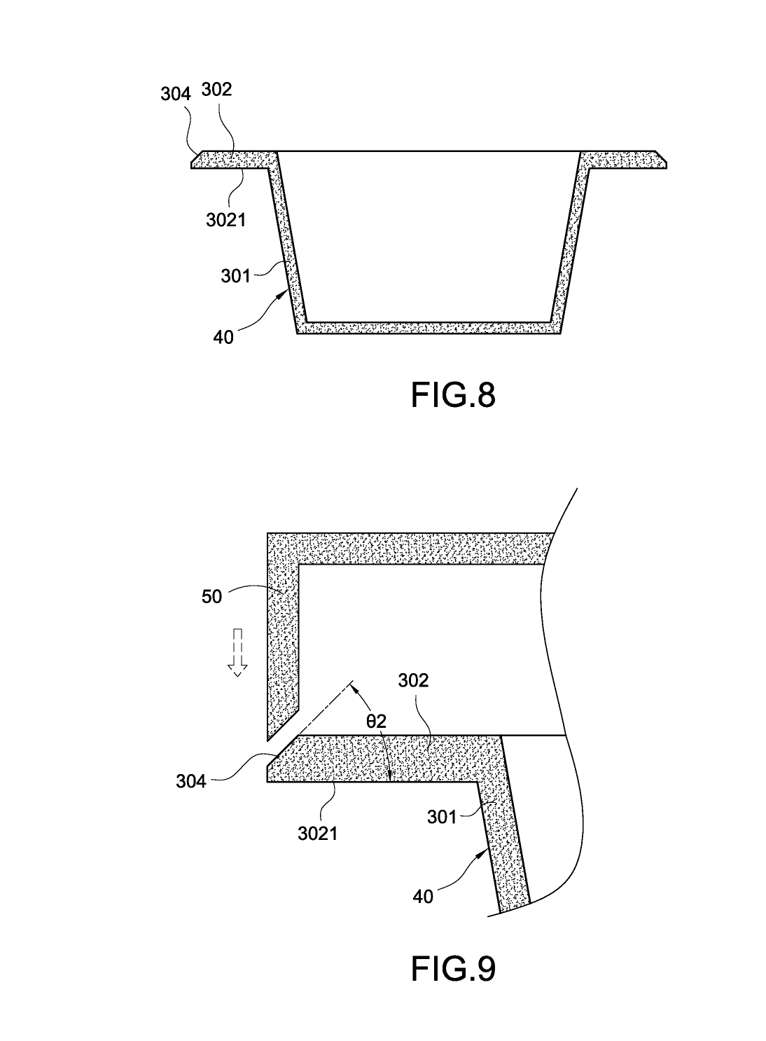

In FIGS. 8 and 9, the external periphery of the paper product 40 has the inclined edge 304. Compared with the conventional perpendicular edge, the inclined edge 304 is capable of improving the contact area and friction, so that when the inclined edge 304 of the paper product 40 is in contact with the package cover 50, the stability of stacking the paper product 40 onto the package cover 50 is improved.

Since the inclined edge 304 is formed by being compressed by the inclined wall 213, therefore the compressed area of the inclined edge 304 has a greater density and a better structural strength, so as to combine with the package cover 50 more securely.

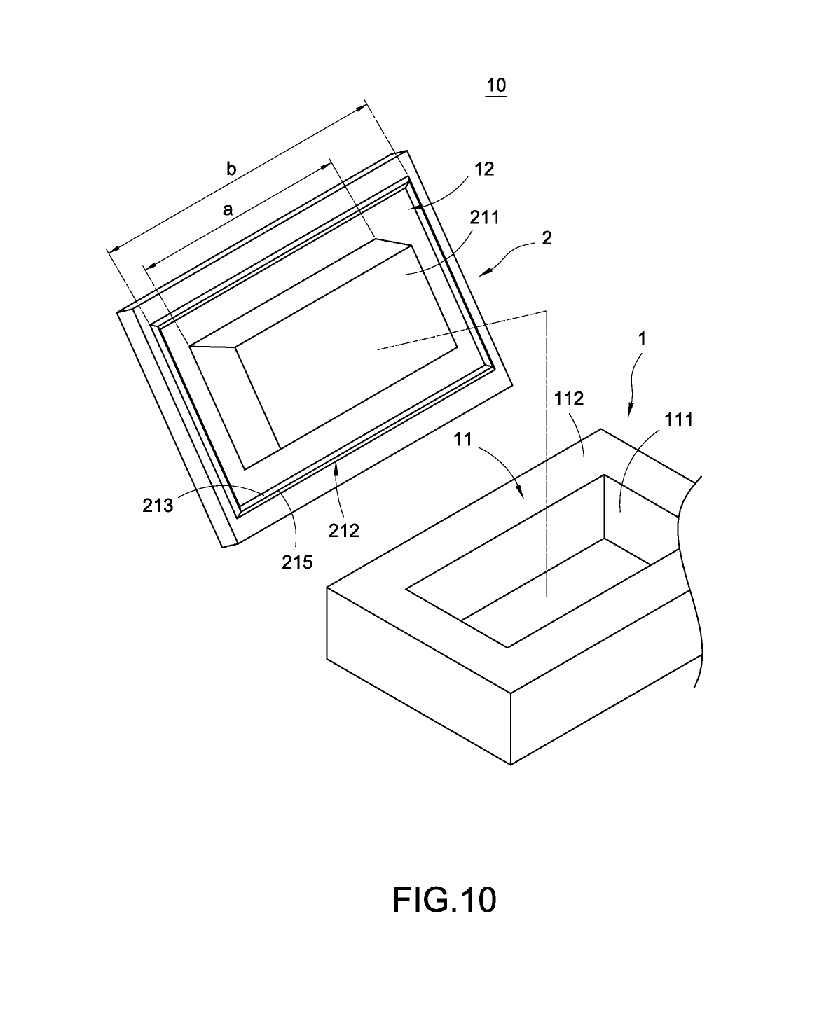

With reference to FIG. 10 for another exemplary embodiment of a hot pressing mold 10 of this disclosure, this exemplary embodiment is substantially the same as the exemplary embodiment as shown in FIGS. 2 to 9, except that the ridge 212 of this exemplary embodiment is an annular projection 215.

Specifically, the ridge 212 is an annular projection 215 disposed around the periphery of the second mold cavity 211, so that when the paper preliminary formed product 30 is compressed by the ridge 212 and the planar section 112 to form the extension plate 302 and trench 303, the trench 303 is formed around the periphery of the main body 301, and the inclined edge 304 is formed around the whole external periphery of the paper product 40, so as to achieve the same functions and effects of the exemplary embodiment as shown in FIGS. 2 to 9.

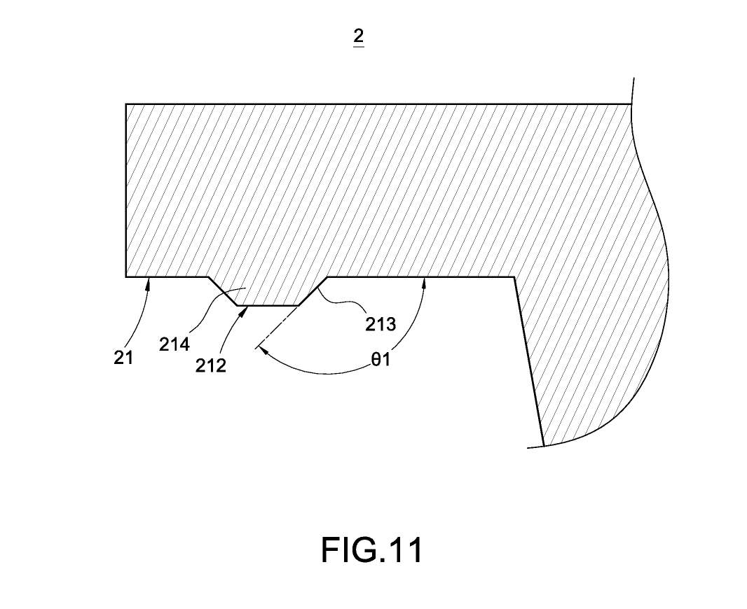

With reference to for FIG. 11 for a further exemplary embodiment of a hot pressing mold 10 of this disclosure, this exemplary embodiment is substantially the same as the exemplary embodiment as shown in FIGS. 2 to 9, except that the ridge 212 has a cross-section in a trapezium shape.

Specifically, the ridge 212 has a cross-section in a geometric shape such as a triangular shape or a trapezium shape. Regardless of the cross-sectional shape of the ridge 212 being a triangular shape, a trapezium shape, or any geometric shape, the inclined wall 213 is formed on a side of the ridge 212 near the second mold cavity 211.

In summation of the description above, the hot pressing mold for pulp molding of this disclosure and its manufacturing method comply with patent application requirements, and thus are duly filed for patent application. While this disclosure has been described by means of specific embodiments, numerous modifications and variations could be made thereto by those skilled in the art without departing from the scope and spirit of this disclosure set forth in the claims.

What is claimed is:

1. A hot pressing mold for pulp molding, comprising:
a first mold, having a first surface, a first mold cavity formed on the first surface, and a planar section disposed around the periphery of the first mold cavity; and
a second mold, engaged with the first mold, and having a second surface, a second mold cavity being formed on the second surface, and a ridge being disposed on an outer side of the second mold cavity, and the ridge having an inclined wall disposed on a side proximate to the second mold cavity, and an obtuse angle being included between the inclined wall and the second surface, and the second mold cavity being pressed and engaged with the first mold cavity, and the ridge being pressed and engaged with the planar section.

2. The hot pressing mold for pulp molding as claimed in claim 1, wherein the obtuse angle falls within a range from 120 degrees to 150 degrees.

3. The hot pressing mold for pulp molding as claimed in claim 1, wherein the second mold cavity has a length smaller than the length of the ridge.

4. The hot pressing mold for pulp molding as claimed in claim 3, wherein there are two ridges, and the two ridges are configured on both sides of the second mold cavity respectively, and each of the ridges is a long-strip projection.

5. The hot pressing mold for pulp molding as claimed in claim 4, wherein the ridge has a cross-section in a triangular shape or a trapezium shape.

6. The hot pressing mold for pulp molding as claimed in claim 3, wherein the ridge is an annular projection disposed around the periphery of the second mold cavity.

7. The hot pressing mold for pulp molding as claimed in claim 6, wherein the ridge has a cross-section in a triangular shape or a trapezium shape.

8. The hot pressing mold for pulp molding as claimed in claim 1, wherein the first mold cavity is a female mold cavity, and the second mold cavity is a male mold cavity.

9. A manufacturing method for pulp molding, comprising the steps of:
(a) providing a hot pressing mold which includes a first mold and a second mold, wherein the first mold has a first surface, a first mold cavity formed on the first surface has and a planar section disposed around the periphery of the first mold cavity, and the second mold has a second surface, and the second surface includes a second mold cavity and a ridge disposed on an outer side of the second mold cavity, and the ridge has an inclined wall on a side of the ridge near the second mold cavity, and an obtuse angle is included between the inclined wall and the second surface;
(b) providing a paper wet blank, and putting the paper wet blank on the first mold;
(c) performing mold clamping and heating operations of the second mold and the first mold, so that the paper wet blank is hot pressed to form a paper preliminary formed product, and the paper preliminary formed product is pressed by the second mold cavity and the first mold cavity to form a main body, and the paper preliminary formed product is pressed by the ridge and the planar section to form an extension plate and a trench, and the interior of the trench is pressed by the inclined wall to form an inclined edge, and the inclined edge has a bottom edge;
(d) performing a mold opening operation of the second mold and the first mold, so that the paper preliminary formed product is detached from the hot pressing mold; and
(e) aligning the bottom edge precisely for the cutting operation, so that the paper preliminary formed product is cut into a paper product, and the inclined edge is formed at the external periphery of the paper product.

10. The manufacturing method as claimed in claim 9, wherein the obtuse angle as described in Step (a) falls within a range from 120 degrees to 150 degrees, and the angle included between the bottom surface of the extension plate and the inclined edge as described in Step (c) falls within a range from 30 degrees to 60 degrees.

11. The manufacturing method as claimed in claim 9, wherein the second mold cavity as described in Step (a) has a length smaller than the length of the ridge.

12. The manufacturing method as claimed in claim 11, wherein there are two ridges as described in Step (a), and the two ridges are disposed on both sides of the second mold cavity respectively, and each of the ridges is a long-strip projection, and as the trench as described in Step (c) comes with a quantity of two, and the two trenches are disposed on both sides of the main body respectively.

13. The manufacturing method as claimed in claim 12, wherein the ridge has a cross-section in a triangular shape or a trapezium shape.

14. The manufacturing method as claimed in claim 11, wherein the ridge as described in Step (a) is an annular projection disposed around the periphery of the second mold cavity, and the trench as described in Step (c) is disposed around the periphery of the main body.

15. The manufacturing method as claimed in claim 14, wherein the ridge has a cross-section in a triangular shape or a trapezium shape.

16. The manufacturing method as claimed in claim 9, wherein the cutting operation as described in Step (e) provides a cutting tool cuts precisely at the bottom edge by punching.

17. The manufacturing method as claimed in claim 9, wherein the cutting operation as described in Step (e) provides a cutting tool cuts precisely at the bottom edge by bending.

18. The manufacturing method as claimed in claim 9, wherein the first mold cavity as described in Step (a) is a female mold cavity, and the second mold cavity as described in Step (a) is a male mold cavity.
